(19) United States
(12) Patent Application Publication
(10) Pub. No.: US 2026/0076316 A1
(43) Pub. Date: Mar. 19, 2026

(54) BENTONITE-CONTAINING HYDROGELS AND RELATED METHODS

(71) Applicant: VELOCIGRO INC., Monrovia, CA (US)

(72) Inventors: Timothy Cuthbertson, Pasadena, CA (US); Jonathan Romo, Fullerton, CA (US); Isabel N. Smith, Los Angeles, CA (US)

(21) Appl. No.: 19/324,452

(22) Filed: Sep. 10, 2025

Related U.S. Application Data
(60) Provisional application No. 63/694,279, filed on Sep. 13, 2024.
(60) Provisional application No. 63/760,811, filed on Feb. 20, 2025.

(51) Int. Cl. A01G 24/22; A01G 22/05; A01G 22/15; A01G 24/44

(52) U.S. Cl. CPC A01G 24/22; A01G 24/44; A01G 22/05; A01G 22/15

(57) ABSTRACT

Horticultural hydrogels are provided that include bentonite. Methods of increasing plant mass and processes for manufacturing/preparing horticultural hydrogels are also provided.

### CROSS-REFERENCE TO RELATED APPLICATIONS

This application claims priority to U.S. Provisional Patent Application No. 63/694,279, filed Sep. 13, 2024, and to U.S. Provisional Patent Application No. 63/760,811, filed Feb. 20, 2025, the contents of which are each incorporated herein.

### BACKGROUND

Common plant growth substrates have marked disadvantages. Soil is known to contain numerous animal and plant pests and undesirable microbes. Even sterilized soil may have harmful residues from such pathogens, and heat-tolerant microbes or spores that can infect the plant as it grows. The common growth substrate peat has been regulated due to sustainability issues, whereas others, like coco-peat, can be acidic or contain contaminants. Other alternatives such as fly-ash, tea waste, paper pulp, pine bark, green waste compost, spent mushroom substrate, and recycled rockwool have been tested, but not fully developed for commercial use. Hydrogels offer several advantages, including sustainability and the ability to decompose into organic components. While their resilience throughout the plant lifecycle and their potential benefits, such as reduced germination time and increased biomass, are promising, these advantages have yet to be fully realized and remain significantly limited. Thus, there remains a need for hydrogels that include alternative, cost-efficient components that still result in hydrogels that are resilient and capable of sustaining a plant from plant to harvest.

### BRIEF SUMMARY OF THE DISCLOSURE

The present disclosure provides horticultural hydrogels for the germination, growth, or sporulation of plants or fungi. Particularly, the present disclosure provides horticultural hydrogels that include bentonite as well as processes for manufacturing/preparing horticultural hydrogels that retain large amounts of water, resist breakdown on dehydration, decrease time to germination, increase plant biomass, and are antimicrobial. The horticultural hydrogels may be prepared and employed from germination to harvest. The horticultural hydrogels may be resilient enough to be compatible with vertical and horizontal automated indoor growing systems that may employ robotics for plant transplantation and growth. The horticultural hydrogels may also be used in conjunction with field production machinery as well as physical human labor transplanting.

According to one aspect, the horticultural hydrogels described herein may include a combination of water, carrageenan, and bentonite. The bentonite used in the horticultural hydrogels may specifically be calcium bentonite, and the formulation can be opaque, substantially transparent or black. The horticultural hydrogels may also include additional components such as carbon, which may be in an activated form, and microcrystalline cellulose. The horticultural hydrogels may further incorporate at least one type of fertilizer, biostimulant, or biofertilizer, with potential fertilizers including nitrogen, calcium, boron, copper, iron, manganese, molybdenum, zinc, or any combination of these elements. According to one embodiment, the horticultural hydrogels may further include one or more essential or inessential plant nutrients and stimulants such as vitamin B1, cobalt, aluminum, selenium, or nickel. According to one embodiment, the horticultural hydrogels may include bentonite but are free of microcrystalline cellulose.

According to one embodiment, the horticultural hydrogels (hydrated, dehydrated, and rehydrated the horticultural hydrogels) can have various physical properties, such as a hardness ranging from about 40 grams to about 2500 grams, a cohesiveness of about 55% to about 90%, and a springiness of about 90% to about 99.9%. When seeds are placed in the hydrogel, the plant mass produced can increase compared to plants grown in coir, peat, or plants grown in hydrogels without bentonite. This increase in plant mass may range from about 5%, 10%, 20%, 30%, 40%, 50% or more. Additionally, the hydrogel may double the germination rate of spinach seeds compared to traditional media such as soil, peat, or coir.

The composition of the horticultural hydrogels may include various components based on the total weight of the horticultural hydrogel. According to one aspect, the horticultural hydrogels include from about 90% to 99% water, about 0.5% w/w to about 5% w/w carrageenan, and about 0.5% w/w to about 5% w/w bentonite. The horticultural hydrogels can also be formulated to be freeze-dried and reconstituted to a water content between about 90% w/w and about 99.9% w/w based on the total weight of the horticultural hydrogel. Alternatively, the horticultural hydrogels can be frozen to below 32° F. and thawed to at least 65° F. at least once. Even if the horticultural hydrogel loses water content, the horticultural hydrogels can be rehydrated to reach a water content of about 90% w/w to about 99.9% w/w based on the total weight of the horticultural hydrogel.

The horticultural hydrogels can support various types of plants from ornamental to edible. Such types of plants include, but are not limited to, vegetables, fruits, flowers, herbs, trees and shrubs. Examples of such types of plants include, but are not limited to, leafy greens (kale, spinach, lettuce, bok choy, arugula, mizuna, chards, collards, sorrel, watercress and beets), root crops (potatoes, beets, radish, kohlrabi, turnips, and carrots), alliums (berries, tomatoes, watermelon, and honeydew), fruit (raspberries, strawberries, blackberries, blueberries, bell peppers, sweet peppers), and herbs (basil, thyme, rosemary, cilantro, mint).

The horticultural hydrogels can be formulated as a mat, allowing for a convenient and effective application. Formulating horticultural hydrogels as mats offers several practical advantages. Mats provide controlled and uniform water distribution, ensuring consistent moisture around plant roots. Mats also reduce leaching and runoff, keeping nutrients in place and minimizing environmental impact. Mats are also easier to handle and apply than loose hydrogels, making them ideal for use in containers, garden beds, and landscaping.

In addition to water retention, hydrogel mats can help suppress weeds and reduce soil erosion, functioning similarly to mulch. Mats may create a stable, hydrated environment that supports strong root development, particularly in seedlings and transplants. Some mats can be reused across planting cycles and may be infused with nutrients or additives for controlled release. This combination of efficiency, ease of use, and versatility makes hydrogel mats a valuable tool in horticultural applications.

According to another aspect, the horticultural hydrogels may include from about 90% w/w to 99% w/w, about 0.5% w/w to about 5% w/w carrageenan, and about 0.5% w/w to about 5% w/w bentonite with all component weights based on the total weight of the horticultural hydrogel. Optional components may be included in the horticultural hydrogels such as about 0.01% w/w to about 3% w/w carbon, about 0.01% w/w to about 3% w/w microcrystalline cellulose, and about 0.01% w/w to about 3% w/w of at least one fertilizer, biostimulant, or biofertilizer. The horticultural hydrogels provided herein may be freeze-dried, reconstituted, or frozen and thawed, retaining the ability to lose and regain water content.

The horticultural hydrogels, formulated as a mat or otherwise, may also have a hardness ranging from about 40 grams to about 2500 grams, a cohesiveness of about 55% to about 90%, and a springiness of about 90% to about 99.9%. Bentonite may enhance plant mass growth compared to the same hydrogel without bentonite, with an increase of plant mass growth of at least about 5%, 10%, 20%, 30%, 40%, 50% or more. The horticultural hydrogels according to this embodiment are suitable for growing various leafy greens, berries, peppers, and herbs.

According to another aspect, a method of increasing plant mass is provided. The method includes the steps of providing a horticultural hydrogel as provided herein and introducing a plant seed to the hydrogel. The method may optionally include introducing water to the hydrogel.

According to another aspect, a method of preparing a horticultural hydrogel is provided. The method includes the steps of heating water to a temperature of from about 80° C. to about 90° C.; introducing one or more components to the heated water to form a mixture, the one or more components selected from the group consisting of carrageenan, calcium bentonite clay, acidic activated carbon, calcium nitrate, and micronutrient fertilizer; introducing the mixture to plant plug mold; cooling the mixture within the plug mold to form a solidified horticultural hydrogel; blast freezing or applying cryogenic gas to the solidified horticultural hydrogel; and dehydrating the solidified horticultural hydrogel. According to one embodiment, the water is reverse-osmosis purified water. According to one embodiment, the water is heated to about 85° C. According to one embodiment, the method further includes a step of mixing the one or more components with the heated water. According to one embodiment, the mixing is carried out with a low-shear impeller at about 400 RPM. According to one embodiment, the mixing is carried out for about 30 minutes.

According to one embodiment, the method further includes the step of cold quenching where the mixture is initially more concentrated but then cool water is added after 30 minutes at 85° C. The cool water immediately adjusts the temperature to a pouring temperature and results in a normal dilution. The advantages of this are that the hydrogel is not damaged by remaining at the high temperature for too long, and the necessity for an expensive heat pump chiller is removed.

According to one embodiment, the method includes the steps of cooling the mixture to about 70° C. and maintaining the mixture temperature at about 65° C. until introduction of the mixture to the plant plug mold. According to one embodiment, the step of cooling the mixture within the plug mold to form a solidified horticultural hydrogel is carried out at about 4° C. According to one embodiment, the horticultural hydrogel may be subject to a step of blast freezing or applying cryogenic gas at about −40° C. or less (colder) for at least 8 hours. If freezing is conducted at a warmer temperature (in a −4° C. household freezer for instance), freezing is slowed and large ice crystals may form in the gel. The larger ice crystals may destroy some of the critical microscopic structure of the hydrogel, weakening the gel in the process. To avoid such impact, freezing may be undertaken via blast freezing or via applying at least one cryogenic gas such as liquid nitrogen or liquid carbon dioxide. According to a particular embodiment, the step of blast freezing is carried out with liquid nitrogen. According to one embodiment, the horticultural hydrogel may be used directly for planting without freezing or drying. According to one embodiment, the method further includes a step of dehydrating the solidified horticultural hydrogel. The dehydration step may be carried out in a dehydration chamber at about 25° C.

Overall, the horticultural hydrogels described herein provide a versatile and effective medium for promoting plant growth, offering a range of compositions and applications to suit different types of plants and growing conditions.

### BRIEF DESCRIPTION OF THE DRAWINGS

FIG. 1. Illustrates the change in plug hardness over time amongst horticultural hydrogel plugs in varying conditions.

### DETAILED DESCRIPTION OF THE DISCLOSURE

Unless otherwise defined, all terms of art, notations and other scientific terms or terminology used herein are intended to have the meanings commonly understood by those of skill in the art to which this disclosure pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

### Definitions

The singular form “a”, “an”, and “the” include plural references unless the context clearly dictates otherwise. For example, the term “a cell” includes one or more cells, including mixtures thereof.

As used herein, the term “ambient temperature” refers to a temperature of between 18-24° C. and a relative humidity of between 60-95%.

As used herein, the term “bentonite” refers to a natural clay or nanoclay composed mainly of smectite that may be included in the horticultural hydrogel plugs provided herein. Bentonite may include volcanic ash and montmorillonite. The bentonite provides attractive physical characteristics including sorption capacity, swelling ability, water resistance, mechanical stability and structural strength. The term “bentonite” as provided herein may refer to and includes an alkali earth metal form such as sodium bentonite, calcium bentonite, and potassium bentonite.

As used herein, “biofertilizers” are microbial fertilizers that supply the plant with nutrients and thereby can promote plant growth in the absence of chemical fertilizers. Biofertilizers that can directly promote plant growth and/yield include, but are not limited to, nitrogen-fixing bacteria Rhizobium and Bradyrhizobium species that, through symbiotic nitrogen fixation, can form nodules on roots of leguminous plants and convert atmospheric N₂ into ammonia which, in contrast to atmospheric N₂, can be used by the plant as a nitrogen source. Other examples of biofertilizers include Azospirillum species, which are free-living nitrogen-fixers that can fertilize and increase yield of cereal crops such as wheat, sorghum, and maize. Despite Azospirillum's nitrogen-fixing capacity, the yield increase caused by inoculation by Azospirillum is often attributed to increased root development and, thus, to increased rates of water and mineral uptake. In this respect, several rhizobacteria like Azotobacter spp. have been reported to be capable of producing a wide array of phytohormones (e.g., auxins, cytokinins) and enzymes (e.g., pectinase). Many of these phytohormones and enzymes have been shown to be intimately involved in the infection process of symbiotic bacteria-plant associations which have a regulatory influence on nodulation by Rhizobium. Biofertilizers can also affect the plant growth and development by modifying nutrient uptake. Biofertilizers may alter nutrient uptake rates, for example, by direct effects on roots, by effects on the environment which in turn modifies root behavior, and by competing directly for nutrients (Gaskin et al., Agricult. Ecosyst. Environ. 12: 99-116, 1985). Some factors by which biofertilizers may play a role in modifying the nutrient use efficiency in soils include, for example, root geometry, nutrient solubility, and nutrient availability by producing plant compatible ion forms partitioning of the nutrients in plant and utilization efficiency. For example, a low level of soluble phosphate can limit the growth of plants. Some plant growth-promoting microbes are capable of solubilizing phosphate from either organic or inorganic bound phosphates, thereby facilitating plant growth. Several enzymes of microbial origin, such as nonspecific phosphatases, phytases, phosphonohydrolases, and C-P lyases, release soluble phosphorus from organic compounds in soil. For example, an increased solubilization of inorganic phosphorus in soil has been found to enhance phosphorus uptake in canola seedling using Pseudomonas putida as well as increased sulfur-oxidation and sulfur uptake (Grayston and Germida, Can. J. Microbiol. 37: 521-529, 1991; Banerjee, Phytochemicals and Health, vol. 15, May 18, 1995).

As used herein, the term “biostimulants” refers to substances that stimulate the growth of plants in the absence of pathogens. For example, the production of plant hormones is a characteristic of many plant-associated microorganisms. Some microorganisms can also produce secondary metabolites that affect phytohormone production in plants (e.g., auxin) which can promote root growth. Examples of biostimulants include pseudomonads which have been reported to produce indole acetic acid (IAA) and to enhance the amounts of IAA in plants, thus having a profound impact on plant biomass production (Brown, Annual Rev. Phytopathology, 68: 181-197, 1974). For example, Tien et al. (Applied Environmental Microbiol., 37:1016-1024, 1979) reported that inoculation of nutrient solutions around roots of pearl millet with Azospirillum brasiliense resulted in increased shoot and root weight, an increased number of lateral roots, and all lateral roots were densely covered with root hairs. Plants supplied with combinations of IAA, gibberellins and kinetin showed an increase in the production of lateral roots like that caused by Azospirilla. Additionally, some rhizobacteria, such as strains of the bacterial species B. subtilis, B. amyloliquefaciens, and Enterobacter cloacae, function as biostimulants by promoting plant growth by releasing volatile organic compounds, VOCs. The highest level of growth promotion has been observed with 2,3-butanediol and 3-hydroxy-2-butanone (also referred to as acetoin) as elicitors of induced systemic resistance. The cofactor PQQ has been described as a plant growth promoter, which acts as an antioxidant in plants. Other examples of biostimulants, as contemplated by the present disclosure, include products listed at https: growerssecret.com. Particularly, Grower's Secret Professional, Seaweed Powder 0-0-16, Soluble Corn Steep Powder 7-6-4, Granule's 8-3-1, Nitrogen 16-0-0, Liquid Nitrogen 8-0-0, Grower's Secret Microbes, Phosphorous 0-9-0, Seaweed Powder 0-0-16, or VitalVit Micronutrients. Other biostimulants include silica, amino acids, or agriculturally relevant enzymes.

As used herein, the term “carbon” includes charcoal. Carbon may be commercially sourced from General Carbon™, Fisher Scientific™ and VWR™.

As used herein, the term “carrageenan” refers to an anionic polymer, a sulfated linear polysaccharide. Carrageenan have been classified into three different types, namely, K-carrageenan, t-carrageenan, and A-carrageenan based on the degree of sulfation.

Carrageenan, as is contemplated in the present disclosure, includes any one or more type of carrageenan. According to one embodiment, the carrageenan may be kappa carrageenan, which has the highest hydrogel forming efficiency. The source may be purchased commercially such as Ricogel™, Marcel, W-Hydrocolloids™ or CP Kelco™. Carrageenan can also be purified from red algae as is known by those skilled in the art.

As used herein, the term “dibble” refers to an indention suitable to receive a seed, plurality of seeds, spore, plurality of spores, or mycelium. The dibble may be created in the hydrogel through the use of an auger or dibbler. The size of the dibble is dependent on the use (e.g., smaller dibble for smaller seeds).

As used herein, the term “fertilizer” refers to a substance that provides nutrients or macronutrients such as phosphorus, nitrogen, carbon, hydrogen, oxygen, potassium, calcium, magnesium, sulfur, iron, boron, copper, manganese, zinc, molybdenum, chlorine, cobalt, silica, chlorine, or nickel whether synthetic or organic. Suitable fertilizers may be commercially sourced, such as Miracle-Gro water soluble plant food vegetable and herbs, Clonex™, Dyna-Gro™, M&S™ (Murashige and Skoog) or FloraMicro™. Fertilizers as provided here may be generally classified according to their NPK content. NPK is common terminology used in the fertilizer industry and stands for: (1) N—the amount of nitrogen in the formulation as N; (2) P—the amount of phosphorus in the formulation as P₂O₅; and (3) K—the amount of potassium in the formulation as K₂O. In other words, the N refers to nitrogen-containing compounds that are added to the soil and are utilized by the particular plant to satisfy its nitrogen requirement. The P refers to phosphorus-containing compounds that are added to the soil and are utilized by the particular plant to satisfy its phosphorus requirement (a nutrient required for plant growth). K refers to potassium-containing compounds that are added to the soil and are utilized by the particular plant to satisfy its potassium requirement (another nutrient essential for plant growth). Besides these nutrients, namely nitrogen, phosphorus and potassium, which are normally provided by the addition of fertilizers that typically are known as NPK fertilizers, other nutrients can also be provided by the addition of fertilizers to the soil. Typical nutrients are calcium, magnesium, sulfur, iron, zinc, manganese, copper, boron, and molybdenum. The term “fertilizer” as used herein may refer to NPK fertilizers that include one or more of the nutrients (nitrogen, phosphorus and potassium).

As used herein, the term “cohesiveness” refers to the internal strength or structural integrity of a plug, which determines how well the gel holds together as a single entity (ability to resist deformation or breaking apart under mechanical stress). The cohesive properties of a substance are expressed quantitatively in the cohesive energy. This quantity is closely related to the internal pressure, a parameter appearing in the equation of state of the substance. According to the present disclosure, cohesiveness is measured using a texture analyzer by compressing two flat plates against the horticultural hydrogel plug to compress the horticultural hydrogel plug twice at a fixed rate. The result is reported as the ratio or percentage of the resistance during a second 10% compression compared to the first (e.g., 9 g vs. 10 g=90%).

As used herein, the term “hardness” refers to the resistance of a material to permanent indentation. According to the present disclosure, hardness is measured using a texture analyzer by compressing two flat plates against the horticultural hydrogel plug to compress the horticultural hydrogel plug twice at a fixed rate and measuring the maximum force required to achieve a specific deformation (e.g., indentation). The result is reported in grams, gram-force (gf), Newtons, pound-force, or grams/cm² and is the force required to compress the horticultural hydrogel plug by 10% (e.g., a 1.0 cm horticultural hydrogel plug to 0.9 cm).

As used herein, the term “hydrogel” is a crosslinked hydrophilic polymer that does not dissolve in water. Hydrogels are highly absorbent yet maintain well defined structures.

As used herein, the term “organic” means components that have been certified as organic from the USDA National Organic Program.

As used herein, the term “organic materials” means carbon-based materials such as soil, wood or wood components (e.g., shavings), peat, coir, and other natural materials.

As used herein, the term “plant” or “plant part” includes all parts of the plant, including: root, stem, meristem, seed, leaf, cotyledons, and the like.

As used herein, the term “plant plugs” or “plugs” or “horticultural hydrogel plug” may be used interchangeably (commonly referred to as in vitro plugs) herein and refers to relatively small shaped bodies composed of a growth medium that serve for the cultivation and propagation of plants in a very early developmental stage. Plant plugs generally have a consistency which allows a manual or machine transfer of the plugs into other cultivation vessels or transport or processing units. Owing to their small size and transferability, plant plugs can be suitable for medium- and high-throughput methods in plant cultivation and can also be used for the space-saving transport of plants in an early developmental stage. The plugs may be opaque, substantially transparent or substantially dark (e.g., black).

As used herein, the term “polysaccharide” refers to a carbohydrate (e.g. starch, cellulose, or glycogen) whose molecules include of a number of sugar molecules bonded together. Polysaccharides include gellan.

As used herein, the term “purity” refers to carrageenan purity as determined by SEC-HPLC (Size Exclusion Chromatography-High Performance Liquid Chromatography) peak height. To determine purity via SEC-HPLC, carrageenan is dissolved in a water/acetonitrile mixture, run through the size-exclusion column, and eluted to separate components by molar mass.

As used herein, the term “soil” means either man-made or naturally occurring unconsolidated mineral or organic material on the immediate surface of the Earth that serves as a natural medium for the growth of land plants. Soil used for indoor growing is generally sterilized and devoid of added living biologic material.

As used herein, the term “springiness” refers to the rate (percentage) or ratio at which a deformed material (elastic recovery) goes back to its undeformed condition after deforming force is removed. According to the present disclosure, springiness is measured using a texture analyzer by compressing two flat plates against the horticultural hydrogel plug to compress the horticultural hydrogel plug twice at a fixed rate. The result is reported as the recovered height of the plug during the second compression, expressed as a percentage of the original.

As used herein, the term “water” includes purified, distilled and reverse osmosis (RO) water, which may be charged as in some embodiments of the present disclosure.

As used herein, the term “% w/w” refers to the percentage of a component based on the total weight of the horticultural hydrogel.

All publications and patent applications mentioned in this specification are herein incorporated by reference to the same extent as if each individual publication or patent application was specifically and individually indicated to be incorporated by reference.

No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents forms part of the common general knowledge in the art.

The discussion of the general methods given herein is intended for illustrative purposes only. Other alternative methods and embodiments will be apparent to those of skill in the art upon review of this disclosure.

### Horticultural Hydrogel

Horticultural hydrogels are provided that are cost-efficient to manufacture while retaining physical properties and performance suitable for plant germination and growth. The horticultural hydrogels provided herein may be formulated as plugs. Such plugs may be wet, freeze-dried or freeze-thawed. When freeze-dried or freeze-thawed, the horticultural hydrogels provided herein may be rehydrated for use. The horticultural hydrogels provided herein may be formulated as mats.

According to one embodiment, the horticultural hydrogels provided herein include at least one polysaccharide polymer. The polysaccharide polymer may be an alginate or derivative thereof such as carrageenan, chitins, chitosan and derivatives thereof, cellulose and derivatives thereof, starch and derivatives thereof, cyclodextrin, dextran and derivatives thereof, gums, lignins, pectins, saponins, deoxyribonucleic acids, and ribonucleic acids.

According to one embodiment, the horticultural hydrogels provided herein may include at least one polymer that is a polypeptide or protein such as albumin, bovine serum albumin, casein, collagen, fibrinogen, gelatin and derivatives thereof, gliadin, sodium glycine carbonate, bacterial cell membrane enzymes, and poly(amino acids). The poly(amino acid) may include polyproline, poly(L-arginine), poly(L-lysine), polysarcosine, poly(L-hydroxyproline), poly(glutamic acid), poly(S-carboxymethyl-L-cysteine), and poly(aspartic acid).

According to one embodiment, the horticultural hydrogels provided herein may include at least one polymer that a synthetic polymer such as a homo- or co-polymer that includes a monomer such as acrolein potassium, (meth)acrylamides, (meth)acrylic acid and salts thereof, (meth)acrylates, acrylonitrile, ethylene, ethylene glycol, ethyleneimine, ethyleneoxide, styrene sulfonate, vinyl acetate, vinyl alcohol, vinyl chloride, and vinylpyrrolidone.

According to one embodiment, the horticultural hydrogels provided herein may include at least one polymer that a naturally occurring polysaccharide, including the natural polymers of alginic acid, carrageenan, chitosan, and carboxymethylcellulose (and its derivatives), positively and negatively charged polyelectrolytes (PEL), synthetic polymers, such as polyacrylonitrile (PAN) and poly(vinyl alcohol) (PVOH), film-forming polymer emulsions, e.g., homo/multi-polymers of vinyl acetate and various (meth)acrylate derivatives (e.g., methyl, ethyl, butyl), natural or synthetic rubber emulsions and dispersions, natural or chemically modified proteins, polyphenolic compounds, such as tannin-based complexing agents and derivatives thereof, and mixtures thereof.

According to one embodiment, the horticultural hydrogels provided herein may include one or more of polyacrylonitrile, alginic acid (sodium salt, various molecular weights), chitosan (various degrees of deacetylation and molecular weights), carrageenan (kappa), sodium salt of carboxymethylcellulose, pectin, natural and seminatural gums, such as starch, xanthan, gellan, carrageenan, gum arabic, guar gum, ghatti gum, tragacanth gum, pontianac gum, karaya gum, agar-agar, methyl cellulose, and hydroxypropyl methylcellulose, natural and modified proteins, such as gelatin, collagen, albumin, bovine serum albumin, fibrinogen, casein, gliatin and the like, polyphenolic materials, such as tannin, tannic acid, galotannins, catechin, chlorogenic acid, arbutin, and the like, poly(diallydimethyl ammonium chloride), gelatin with tannic acid as complex-forming agent, polyethyleneimine (PEI), and PVOH before being crosslinked by any chemical or physical methods. According to one embodiment, the horticultural hydrogels provided herein may include one or more of an ethylenically-unsaturated monomer that may include acrylamide (AAm), N-isopropyl acrylamide (NIPAM), 2-hydroxyethyl (meth)acrylate (HEA, HEMA), acrylic acid (AAc), salts of acrylic acid (potassium, sodium and ammonium), potassium salt of 3-sulfopropyl acrylate (SPAK), poly(ethylene glycol)acrylate, poly(ethylene glycol)alkyl ether acrylate, methacrylic acid-2-dimethylaminoethyl ester, dimethylaminoethyl acrylate and diallyldimethylammonium chloride (DADMAC).

According to one embodiment, the horticultural hydrogels provided herein may include at least one or more of sodium carboxymethylcellulose, sodium starch glycolate, sodium carboxymethyl starch, dextran, dextran sulfate, chitosan, carrageenan, xanthan, gellan, hyaluronic acid, sodium alginate, pectinic acid, deoxyribonucleic acids, ribonucleic acid, gelatin, albumin, polyacrolein potassium, sodium glycine carbonate, poly(acrylic acid) and its salts, polyacrylonitrile, polyacrylamide, poly(styrene sulfonate), poly(aspartic acid), polylysine, polyvinylpyrrolidone, polyvinyl alcohol, CARBOPOL™, ultramylopectin, poly(ethylene glycol), neutral cellulose derivatives, microcrystalline cellulose, powdered cellulose, cellulose fibers, carbon fibers (including nanotubes), dissolvable suture materials, and starch. Polyamides including vinyl caprolactam, polyethylene glycol, and polylactic acid, polyesters including polyglycolic acid, and dialdehydes may include or be additives to the horticultural hydrogel.

According to one embodiment, the horticultural hydrogels provided herein may include at least one organic material. In these embodiments, measurements for springiness, hardness, and cohesiveness decrease, characterizing the horticultural hydrogel a “wet gel.”

The horticultural hydrogels of the present disclosure may be strengthened through post-crosslinking which may be accomplished chemically, physically or by any other method, including irradiation. Post-crosslinking chemical agents include any multifunctional crosslinkers (e.g., containing hydroxyl, carboxyl, amine, epoxy, amide, urethane groups, and the like), divalent/multivalent metallic cations (e.g., calcium, magnesium, zinc, copper, barium, iron, aluminum, chromium, cerium), phosphates (e.g., pentasodium tripolyphosphate (TPP)), chromates (e.g., dipotassium dichromate), borates (e.g., sodium tetraborate decahydrate), peroxides (e.g., t-butyl hydroperoxide), glycidyl(meth)acrylate, ethylene glycol diglycidyl ether, glutaraldehyde, glycerin, glycols, polyamidoamine epichlorohydrin resin, TMPTA, and the like, and mixtures thereof. Representative crosslinking methods include thermogelation, ionotropic gelation, cryogelation, radiation-induced gelation, chemical gelation, coagulation, crystallization, vulcanization, curing, and combinations thereof. Other post-crosslinking methods employ ionotropic gelation (e.g., using anhydrous calcium chloride, cupric sulfate, ammonium cerium (IV) nitrate, ferric chloride hexahydrate, sodium tetraborate decahydrate, zinc chloride, aluminum chloride hexahydrate, chromium chloride, and anhydrous TPP) and cryogelation (e.g., by applying freeze-thaw cycles to PVOH solutions and using another cryogelable materials).

According to one embodiment, the horticultural hydrogels provided herein include carrageenan as a polysaccharide polymer. The carrageenan may be present in the absence of a second polysaccharide or polymer. According to one embodiment, the horticultural hydrogels provided herein include kappa-carrageenan.

According to one embodiment, carrageenan may be utilized at a purity level so as to distinguish larger polysaccharides from smaller ones (e.g., starches) while maintaining horticultural hydrogel structural integrity and plant growth. In some embodiments, the purity of the carrageenan is between about 55% and about 100%. According to one embodiment, the purity of the carrageenan is at least about 60%, 70%, 80% or 90%. According to one embodiment, the purity of the carrageenan is between about 90% and about 100%. In other embodiments, the horticultural hydrogels provided herein may include iota-carrageenan.

According to one embodiment, the horticultural hydrogels provided herein include about 0.50% w/w to about 5.0% w/w of a polysaccharide such as carrageenan based on the total weight of the horticultural hydrogel. According to one embodiment, the horticultural hydrogels provided herein include at least about 0.50% w/w, 0.60% w/w, 0.7% w/w, 0.8% w/w or more of a polysaccharide such as carrageenan. According to one embodiment, the horticultural hydrogels provided herein include less than about 5.0% w/w, 4.0% w/w, 3.0% w/w or 2.0% w/w of a polysaccharide such as carrageenan. According to one embodiment, the horticultural hydrogels provided herein include from about 0.80% w/w to about 3.0% w/w of a polysaccharide such as carrageenan.

According to one embodiment, the horticultural hydrogels provided herein include bentonite. According to one embodiment, the presence of bentonite increases the strength and integrity of horticultural hydrogels white maintaining or increasing plant growth compared to horticultural hydrogels that do not contain bentonite. According to one embodiment, the horticultural hydrogels provided herein include bentonite in place of microcrystalline cellulose. According to one embodiment, the horticultural hydrogels provided herein include bentonite in addition to microcrystalline cellulose. According to one embodiment, the horticultural hydrogels provided herein include bentonite allowing for use of lower than typical amounts of carrageenan. According to one embodiment, the inclusion of bentonite in the horticultural hydrogels reduces overall production costs.

According to one embodiment, the horticultural hydrogels provided herein include about 0.5% w/w to about 5% w/w bentonite based on the total weight of the horticultural hydrogel. According to one embodiment, the horticultural hydrogels provided herein include at least about 0.5% w/w, about 1.0% w/w, about 2.0% w/w, about 3.0% w/w, about 4.0% w/w or more bentonite. According to one embodiment, the horticultural hydrogels provided herein include less than about 5% w/w bentonite. According to one embodiment, the horticultural hydrogels provided herein include from about 1.0% w/w and about 2.0% w/w bentonite.

According to one embodiment, the horticultural hydrogels as provided herein include water which makes up the remainder of the hydrogel beyond the components provided herein. The water may be filtered or subject to reverse osmosis prior to introduction during manufacturing of the horticultural hydrogel. According to one embodiment, the horticultural hydrogels include at least about 80.0% w/w, about 85% w/w, about 90% w/w or more water based on the total weight of the horticultural hydrogel. According to one embodiment, the horticultural hydrogels include up to about 99.9% w/w water. According to one embodiment, the horticultural hydrogels include from about 91.5% w/w to about 98.5% w/w water. According to one embodiment, the horticultural hydrogels include from about 92.0% w/w water to about 98.0% w/w water.

According to one embodiment, the horticultural hydrogels of the present disclosure retain water content for up to about 250 days. In other embodiments, the horticultural hydrogels of the present disclosure retain water content for up to 21 days, 14 days, 30 days, 45 days, 60 days, 75 days, 90 days, 120 days, 150 days, 180 days, 210 days, 220 days, 230 day, 240 days, 250 days or more. According to one embodiment, the horticultural hydrogels can lose water such that the hydrogel includes about 60% or less and be rehydrated to about 98% without losing efficacy (e.g., increased biomass and decreased time to germination). Thus, the horticultural hydrogels of the present disclosure may have an increased resiliency of water retention and rehydration relative to that known in the art.

In some embodiments the horticultural hydrogels of the present disclosure may be dehydrated by about 10%, 20%, 30%, 40%, 50%, 60%, 70%, 80% or more through freezing and thawing. In other embodiments the horticultural hydrogel is liquid in formulation.

### Optional Horticultural Hydrogel Components

According to one embodiment, the horticultural hydrogels provided herein may optionally include carbon. The carbon may provide antimicrobial properties thus eliminating the need for additive antimicrobial components. The presence of carbon may also result in a black or dark colored horticultural hydrogel. According to one embodiment, the horticultural hydrogels provided herein optionally include at least about 0.0.1% w/w carbon based on the total weight of the horticultural hydrogel. According to one embodiment, the horticultural hydrogels provided herein optionally includes up to about 3.0% w/w carbon. According to one embodiment, the horticultural hydrogels provided herein optionally include up to about 1.0% w/w carbon.

According to one embodiment, the horticultural hydrogels provided herein may optionally include microcrystalline cellulose. Microcrystalline cellulose increases suspension stability, increases shelf life, increases plant growth, increases germination, and decreases biodegradation while in use in the greenhouse. According to one embodiment, the horticultural hydrogels provided herein optionally include at least about 0.01% w/w microcrystalline cellulose based on the total weight of the horticultural hydrogel. According to one embodiment, the horticultural hydrogels provided herein optionally include up to about 3.0% w/w microcrystalline cellulose. According to one embodiment, the horticultural hydrogels provided herein optionally include up to about 0.10% w/w microcrystalline cellulose.

According to one embodiment, the horticultural hydrogels as provided herein may optionally include one or more fertilizers, biostimulants or biofertilizers. According to one embodiment, the one or more fertilizers includes macronutrients, nitrogen (N), phosphorus (P), potassium (K), calcium (Ca), magnesium (Mg) and sulfur (S). According to one embodiment, the horticultural hydrogels may include, for example, macronutrients in the form of KNO₃, NH₄NO₃, MgSO₄×7 H₂O, KH₂PO₄ and/or CaCl₂)×2H₂O. According to one embodiment, the horticultural hydrogels may include one or more fertilizers such as Florapro® Calcium+Micros (NPK of 14-0-0) available from General Hydroponics which includes 14% nitrogen (0.9% ammoniacal nitrogen; 13.1% nitrate nitrogen), 0.06% boron, 0.02% copper, 0.3% iron, 0.09% manganese, 0.007% molybdenum, 0.02% zinc as well as 17% calcium ammonium nitrate. According to one embodiment, the horticultural hydrogels as provided herein include one or more fertilizers, biostimulants or biofertilizers at a concentration of from about 100 to about 2000 ppm.

According to one embodiment, the horticultural hydrogels as provided herein include from about 0.01% w/w to about 3.0% w/w of one or more fertilizers, biostimulants or biofertilizers based on the total weight of the horticultural hydrogel. According to one embodiment, the horticultural hydrogels as provided herein include at least about 0.01% w/w of one or more fertilizers, biostimulants or biofertilizers. According to one embodiment, the horticultural hydrogels as provided herein include up to about 3.0% w/w of one or more fertilizers, biostimulants or biofertilizers.

According to one embodiment, the horticultural hydrogels as provided herein may optionally include one or more additives, such as, for example, nutrients. The horticultural hydrogels can, for example, contain nutrients such as, for example, macronutrients and micronutrients; vitamins, phytohormones, further gelling agents, sugar and/or others. Additives promote or support the growth of the various plant species. According to one embodiment, the one or more additives can directly support plant growth, for example by providing building blocks for the formation of cells or by indirectly supporting plant growth, for example by preventing or curbing the growth of competing organisms, such as bacteria. Suitable vitamins and vitamin-like substances that may be components of the hydrogels of the present disclosure are, for example, thiamine, nicotinic acid, pyridoxine, glycine and myo-inositol. When present, phytohormones control certain growth processes in plants, and so their admixture and concentration are selected depending on the plant species and the purpose of growth (root formation, shoot formation, branching, extension, etc.). Thus, phytohormones may be included in some embodiments of the horticultural hydrogels of the present disclosure. Those skilled in the art are capable of making an appropriate selection of phytohormones, and of the other additives defined herein, and of choosing suitable concentrations in each case. The hydrogel can, for example, include phytohormones from the following groups of active ingredients: abscisic acid, auxins, cytokinins, indole-3-acetic acid (IAA), 4-(indo-3-yl)butyric acid (IBA), 1-naphthylacetic acid (NAA), 6-benzylaminopurine (BAP), kinetin (KIN), zeatin (ZEA) or 2-isopentenyladenine (2iP). The concentrations in the growth medium may be present from about 0.001 to about 50 ppm.

According to one embodiment, the horticultural hydrogels provided herein may optionally include one or more fungi to confer benefit to a plant growing therein. These fungi include, but are not limited to: Dominikia, Rhizobium, Azorhizobium, Prunus maackii, Glomus iranicum, Mycorrhiza, Glomus intraradices, G. mosseae, G. aggregatum, G. etunicatum, Glomus deserticola, G. monosporum, G. clarum, Paraglomus brasilianum, Gigaspora margarita, Rhizopogon villosulus, R. luteolus, R. amylopogon, R. fulvigleba, Pisolithus tinctorius, Suillus granulatus, Laccaria bicolor, L. laccata, Scleroderma cepa, S. itrinum, Trichoderma harzianum Rifai, and T. virens.

According to one embodiment, the horticultural hydrogels provided herein optionally include one or more plant growth promoting bacteria (PGPB) to enhance growth of the plants therein. Suitable examples of PGPBs include, but are not limited to, Beauveria bassiana, Bacillus amyloliquefaciens, and Streptomyces lydicus.

According to one embodiment, the horticultural hydrogels provided herein may include gelatin for stabilization. According to one embodiment, the gelatin is a gelatin foam. The gelatin may have a smaller size than a horticultural hydrogel plug defined herein. According to one embodiment, the gelatin may include colloidal silver or colloidal copper, which thereby confer further sterilizing properties. Appropriate gelatin cubes are, for example, available as Gelatamp™ (Roeko; Coltene, gelatin sponge containing 5% colloidal silver, y-sterile) and Gelita-Spon™(Gelita medical; for example, cube, 10×10×10, 50, GS-310, Art. 00715118, without silver additive, foamed gel).

According to one embodiment, the horticultural hydrogels provided herein may include organic material. Suitable organic materials include peat, coir, silica, wood, shell, husk, sterilized hair or fur, wool, silk, bone, antler fragments, feather, or similar materials that may be added to the hydrogels to impart cavities for root growth and nutrition. According to one embodiment, the horticultural hydrogels provided herein do not include (i.e., are free of) any organic material such as peat, coir, silica, wood, shell, husk, sterilized hair or fur, wool, silk, bone, antler fragments, feather, or similar materials.

According to one embodiment, the horticultural hydrogels provided herein are suitable both for the manual cultivation of plants and for automated or semiautomated and machine cultivation of plants. The horticultural hydrogels provided herein may be utilized for the automated or semiautomated cultivation of plants. In this connection and within the meaning of DIN V 19233, “automated” means that the cultivation is carried out by an apparatus which is equipped such that the apparatus works as intended (i.e., achieves a step forward in the cultivation of plants) without any participation at all by a person or with some participation by a person. In other words, the apparatus works autonomously. In the case of the automated or semiautomated cultivation of plants, a plant shoot or plant clone in particular may be applied to a horticultural hydrogel plug in an automated manner. The plant unit formed from plant part and horticultural hydrogel plug may be transferred into another device, another device part and/or a container and/or the plant unit may be transferred into a larger horticultural hydrogel plug or a soil substrate allowing for the larger horticultural hydrogel plug to be a plant plug according to the disclosure or a different type of horticultural hydrogel plug.

According to one embodiment, the horticultural hydrogels provided herein may be formed to be plant plugs that are suitable for automated transfer and for cultivation of the plant from seed to harvest. The horticultural hydrogel plugs of the present disclosure maintain integrity throughout the growth of the seed to plant harvest and do not require re-planting. Moreover, the horticultural hydrogel plugs of the present disclosure retain water at a higher rate than previously disclosed hydrogels, coir, and peat.

The size of the plant plug, according to some embodiments of the disclosure, may be matched with the plant to be grown, the germination time, the time from germination to harvest, or the size of the harvestable plant grown therein. Relatively large horticultural hydrogel plugs may be produced and used in a “plug-in-plug” system. The horticultural hydrogel plugs provided herein can therefore have, for example, a size of about 0.125 cm³ or greater or about 1 cm³ or greater. The horticultural hydrogel plug may have a volume of from about 0.125 cm³ to about 27 cm³ or from about 10 cm³ to about 18 cm³. According to one embodiment, the horticultural hydrogel plug may be about 14 cm³. The horticultural hydrogel plug according to the disclosure are particularly suitable for automated high-throughput cultivation and may be particularly small in some embodiments. In some embodiments, the horticultural hydrogel plug has a volume of about 27 cm³ or lower, about 16 cm³ or lower, or about 10 cm³ or lower. In some embodiments, the horticultural hydrogel plug may have a volume of up to about 50 cm³, about 100 cm³, about 125 cm³, about 150 cm³ or more. In other embodiments, the horticultural hydrogel plug may have a volume of less than about 150 cm³, about 100 cm³, about 75 cm³, about 50 cm³, or less.

The horticultural hydrogel plug of the present disclosure may utilize a plurality of commercially known trays for forming plugs. According to one embodiment, the hydrogels may be poured into and formed in any of the horticultural products available from T.O. Plastics™ Burpee Company, or Landmark Plastic Corporation including, but is not limited to, plug trays, square plant pots, standard inserts, standard flats, true and slim flats, true and slim inserts, regional inserts & flats, propagation trays, sheet pots, round plant pots, or plant pie containers. In other embodiments, the container may be a basket that supports the hydrogel in a deep-water culture or in a nutrient film technique. In other embodiments, the horticultural hydrogel may be supported in a basket in deep water culture or nutrient film.

According to one embodiment, the horticultural hydrogel plugs may have the shape of a cuboid, for example the shape of a cuboid having substantially equal sides. The horticultural hydrogel plug according to the disclosure is not limited a cuboid shape and may be cylindrical, hexagonal, polygonal, or hemispheric shape. The horticultural hydrogels of the present disclosure may be poured into a sheet suitable for the growth of plants such as microgreens. In some embodiments the horticultural hydrogel plugs of the present disclosure may be included in large pots, creating a “Dutch bucket system.” In these embodiments, approximately 18927 cm³ of liquid hydrogel is poured into a 5-gallon container to harden.

According to one embodiment, the horticultural hydrogel plugs may be formed into the shape of pellets or shreds, varying in size and diameter from about 0.25 to about 6 inches. The pellets or shreds may be mixed with other traditional plant growing substrates such as soil, peat or coir. The pellets may be used in their hydrated or dehydrated form as cut flower water beads. The pellets may be partially or completely dried and grinded into smaller particles to be added to plant substrates or sprinkled on the surface of soil.

In some embodiments the horticultural hydrogels may be freeze-dried. In these embodiments, the freeze-drying offers several advantages including lighter in weight and ease of transport. Additionally, through freeze-drying, the horticultural hydrogels may become more porous, offering additional volume for root architecture and growth. These embodiments can create a “loose fill” that may be advantageous for the cultivation of woody plants.

In other embodiments the horticultural hydrogels may be frozen and thawed to create “loose fill. In yet other embodiments the horticultural hydrogels may be partially dehydrated by freeze-thaw. Freezing the horticultural hydrogels, either by freeze-dry or traditional freezing methods (below 32° C.), allow for the removal of water, making the horticultural hydrogels easier to distribute due to lighter weight.

In other embodiments the horticultural hydrogels are not subject to freezing. According to such an embodiment, dry formulation ingredients are added to vigorously agitated water maintained at about 85±5° C. to form a mixture. The dry formulation ingredients include carrageenan (e.g., Kappa Carrageenan (Ricogel 8800)), bentonite clay, activated carbon, calcium nitrate, microcrystalline cellulose and fertilizer (e.g., Florapro® Calcium+Micros). Once the mixture becomes substantially homogeneous, the stirring rate may be reduced. The temperature may be held at about 85±5° C. for approximately thirty minutes to allow for complete dispersion and hydration of the components. Thereafter, a portion of cooler water may be rapidly added to lower the temperature of the mixture to about 75±5° C. The resulting suspension may then be transferred to a dispensing system configured to deposit the material into molds or trays equipped with dibblers. The filled molds may then be allowed to cool under ambient or controlled conditions until a stable gel forms. Once gelation is complete, dibblers may be removed, leaving cavities in the horticultural hydrogels suitable for planting. The resulting horticultural hydrogels may then be used to support the growth of plants from seeds or cuttings.

In other embodiments, the horticultural hydrogels may support fungal growth. In yet other embodiments, wherein iota-carrageenan is used, the horticultural hydrogels may be liquid.

In some embodiments, the horticultural hydrogel plugs at the upper surface has a dibble. When horticultural hydrogel plugs is a sheet or a mat, the sheet or mat may be abraded for germination of seeds.

### Plants and Fungi

The plants cultivable and propagable according to the disclosure can be any plants which can grow on or in a horticultural hydrogel. The products and methods according to the disclosure are suitable for the cultivation of herbs, vegetables, greens, grasses, succulents, berries, ornamental plants, herbaceous perennials and/or woody plants. Examples of vegetables, including all kinds of leafy greens, include green lettuce, red lettuce, romaine lettuce, iceberg lettuce, butter lettuce, chop suey greens, endive, golden purslane, mina, mizuna, komatsuna, pakchoi, spinach, swiss chard, ruby chard, red mustard, watercress, redskin dwarf sweet pepper, radicchio, baby peppers, bok choy, Chinese broccoli, Chinese celery, curry leaves, lemon grass, pea shoots, sesame leaves, choy sum, tatsoi, frilly mustard, baby spinach, bloomsdale spinach, dakon sprout, salad savoy, frisee, green oakleaf, baby leek, garlic chives, marjoram, purslane sorrel, tarragon, broccoleaf, collard greens, dandelion greens, honey gem lettuce, kohlrabi, mesclun, miner's lettuce, mustard greens, arrowhead spinach, puntarelle, epazote, red watercress, Russian kale, scarlet butter lettuce, tat soi, upland cress, living watercress, broccolini, kale, read oak leaf, red salanova, sprouting broccoli, Chinese broccoli, broccoli rabe, green broccoli, Chinese spinach, mibuna, minutina, hops, cannabis, sweet pepper, ramsons, sprouting onion seeds, ‘little gem’ lettuce, ‘marvel of four seasons’ lettuce, ‘green frills’ mustard, gai choy mustard, land seaweed, Greek cress, summer savory, oriental radish (daikon), Chinese lettuce (Celtuce), fenugreek, Chinese cabbage (yow choy), napa cabbage, rainbow Swiss chard, specialty hot peppers, and Easter white eggplant.

Examples of herbs include rocket (rucola), sorrel, coriander, basil (common), basil (Thai), basil (lemon), Cayenne pepper, garlic chives, wild thyme, thyme (lemon), oregano, rosemary, thyme, chives, sage, cilantro, leaf radish, marjoram, lemon balm, Mache, chervil, dill, marjoram, sorrel, tarragon, ice plant, rhubarb, parsley, collard, celery, fennel, mache, tango, chervil, Italian parsley, rapini, Chinese parsley, green purslane, arugula‘Giove’, basil (purple ruffles), lemon balm, lemon basil, and purple basil. Examples of halophytes include samphire (glasswort), sea aster (spinach), Salsola soda, sea beet, rock samphire, sea kale, New Zealand spinach, saltbush, and alexanders (Smyrnium olusatrum).

Examples of medicinal plants include peppermint, lavender, anisi fructus, echinaceae purpureae, ephedra, holy basil, sage, stevia, valeriana officinalis, ginseng, Peruvian ginseng (Maca), daffodil, crambe, camellia, Russian dandelion, St. John's wort, blue cohosh, roman coriander, holy ghost, masterwort, female ginseng, stinging nettle, yerba mansa, bloodroot, and drumstick tree. In some embodiments, the plants or plant species intended to be cultivated (and hence intended to grow or growing) in the plant cultivation system may be plants growing under the same or similar conditions, such as rucola and basil.

Ornamental plants encompass, for example, Phalaenopsis (orchids), Anthurium and Spathiphyllum. Ornamental plants also include perennials which encompass, for example, Echinacea, Helleborus and Heuchera.

Examples of berries that could be grown on the horticultural hydrogels of the present disclosure are, but not limited to: strawberry, blackberry, raspberry, and blueberry. Berries show a wide range of freeze hardiness that allows specific cultivars to be grown in a wide variety of climates. While berries are generally cultivated by cuttings and propagated in shallow flats with loamy soil, the horticultural hydrogels of the present disclosure protect the delicate root systems and are easily transferrable.

Examples of vegetables that may be cultivated and propagated on the horticultural hydrogels of the present disclosure include, but are not limited to: apples, corn, sunflowers, cotton, soybeans, canola, wheat, rice, sorghum, barley, oats, potatoes, oranges, alfalfa, lettuce, strawberries, tomatoes, peppers, crucifers, pears, tobacco, almonds, sugar beets, beans and other valuable vegetable crops.

In some embodiments the horticultural hydrogels of the disclosure may be used to grow woody plants. Woody plants may include fruit trees, which may be any plant as long as the fruit is edible. The fruit tree may be an herbaceous plant or a woody plant, but a woody plant is preferred. Examples of woody plants include Pinus plants, Prunus plants (Prunus spp., Prunus mume, Prunus tomentosa, Prunus salicina, etc.), Avocado genus (Avocado) plants, Mangofera plants (such as Mangifera indica), Prunus (Myrica) plants, Grapes (Vitis) plants, Apples (Malus) plants, Roses (Rosa) plants, Crocodiles (Persea) plants (such as Avocado (Persea americana)), Pyrus plants (Pyrus serotina Rehder, Pyrus pyrifolia), P. communis, etc.) Peach (Amygdalus) plants (such as sugar beet), Biwa (Eriobotrya) plants (such as Eriobotrya japonica), Diospyros plants (such as oysters)) Castanea plants (such as chestnuts), Matinavi (Actinidia) plants (such as Kiwifruit (Actinidia deliciosa)), Ananas plants (such as Ananas comosus), Citrus plants (Citrus unshiu), Natsumi (Citrus natsudaidai), Hassaku (Citrus hassaku), Feeling (Citrus lyo), grapefruit (Citrus×paradisi), etc.), and the like, preferably a fruit belonging to these. Examples of fruit trees include mango, avocado, bayberry, grapes, apples, roses, ume, japonica, pears (Japanese pears, pears), cherry, loquat, oysters, chestnuts, kiwifruit, plums, pineapples, citrus and pear plants, and Japanese pears. Woody plants also encompass, for example, Lycium, Paulownia and Vaccinium.

According to one embodiment, the horticultural hydrogels provided herein may be used to grow fungi. These embodiments include, but are not limited to the following: Lentula edodes (shiitake), Agaricus spp. (white button), Antrodia spp. (Niu Zang), Plerotus spp. (oyster), Auricularia spp. (wood ear), Volvariella volvacea (straw mushroom), Flammulina velutipes (enokitake), Grifola frondosa (maitake), Ganoderm lucidum, Tremella fuciformis (white jelly or fungus ear), Volvariella volvacea (straw), Ganoderma lucidem (reishi), Hericium erinaceus, and Hypsizygus marmoreus (bunashimeji).

### Horticultural Hydrogel Performance

According to one embodiment, the horticultural hydrogels of the present disclosure provide plant seeds a higher germination rate than those germinated in coir. According to one embodiment, the horticultural hydrogels of the present disclosure provide seeds a higher germination than those germinated in peat. According to one embodiment, the horticultural hydrogels of the present disclosure provide seeds a higher germination than those germinated in soil. According to one embodiment, the horticultural hydrogels of the present disclosure provide seeds a higher germination than horticultural hydrogels without bentonite.

According to one embodiment, the horticultural hydrogels of the present disclosure produce plants that have 5%, 10%, 20%, 30%, 40%, 50%, 60%, 70%, 80%, 90%, 100%, 150%, 200%, 250%, 300%, 350%, or 400% or more biomass than those grown in soil, peat, or coir.

According to one embodiment, the horticultural hydrogels of the present disclosure produce plants that have 5%, 10%, 20%, 30%, 40%, 50%, 60%, 70%, 80%, 90%, 100%, 150%, 200%, 250%, 300%, 350%, or 400% or more biomass than those grown in horticultural hydrogels of the same components except without bentonite.

According to one embodiment, the horticultural hydrogels provided herein provide a substrate that produces more fruiting bodies of fungi than that of traditional fungal growth substrate (e.g., solid substrate fermentation). According to one embodiment, the horticultural hydrogels provided herein provide for cultivation of protoplasts or callus tissue.

According to one embodiment, the horticultural hydrogels provided herein exhibit a hardness of from about 40 g to about 2500 g. According to one embodiment, the horticultural hydrogels provided herein exhibit a hardness of at least about 40 g. According to one embodiment, the horticultural hydrogels provided herein exhibit a hardness of less than about 2500 g. According to one embodiment, the horticultural hydrogels provided herein exhibit a hardness of up to about 2500 g.

According to one embodiment, the horticultural hydrogels provided herein exhibit a cohesiveness of from about 55.0% to about 90.0%. According to one embodiment, the horticultural hydrogels provided herein exhibit a cohesiveness of at least about 55.0%. According to one embodiment, the horticultural hydrogels provided herein exhibit a cohesiveness of up to about 90.0%. According to one embodiment, the horticultural hydrogels provided herein exhibit a cohesiveness of at least about 55.0% for an extended period of time under ambient conditions. According to one embodiment, the horticultural hydrogels provided herein exhibit a cohesiveness of at least about 55.0% for at least about 50 days, 100 days, 150 days, 200 days, 250 days or more under ambient conditions.

According to one embodiment, the horticultural hydrogels provided herein exhibit a springiness of from about 90.0% to about 99.9%. According to one embodiment, the horticultural hydrogels provided herein exhibit a springiness of at least about 90.0%. According to one embodiment, the horticultural hydrogels provided herein exhibit a springiness of up to about 99.9%.

The horticultural hydrogel of the present disclosure is able to maintain springiness and hardness such that the hydrogel may be manipulated by mechanical machinery while providing a growing substrate with decreased germination time and increased biomass at harvest.

### Horticultural Hydrogel Related Methods

A method of preparing a horticultural hydrogel is provided. The method includes the steps of heating water to a temperature of from about 80° C. to about 90° C. According to one embodiment, the water is reverse-osmosis purified water. According to one embodiment, the water is heated to about 85° C. According to one embodiment, the method further includes a step of mixing the one or more components with the heated water. According to one embodiment, the method includes the steps of introducing one or more components to the heated water to form a mixture, the one or more components including carrageenan, calcium bentonite clay, neutral carbon, basic carbon, acidic carbon, any activated carbon, calcium nitrate, potassium nitrate, and micronutrient fertilizer. According to one embodiment, the mixing is carried out with a low-shear impeller at about 400 RPM. According to one embodiment, the mixing is carried out for about 30 minutes.

The method includes the steps of introducing the mixture to plant plug mold. The method includes the steps of cooling the mixture within the plug mold to form a solidified horticultural hydrogel. According to one embodiment, the method further includes the steps of cooling the mixture to 70° C. and maintaining the mixture temperature at about 65° C. until introduction of the mixture to the plant plug mold. According to one embodiment, the step of cooling the mixture including cooling within the plug mold to form a solidified horticultural hydrogel is carried out at about 4° C.

According to one embodiment, the method includes the step of blast freezing or introducing cryogenic gas the solidified horticultural hydrogel to freeze the horticultural hydrogel. According to one embodiment, the step of blast freezing or applying cryogenic gas to the solidified horticultural hydrogel is carried out at about −40° C. for at least 8 hours. According to one embodiment, the cryogenic gas includes liquid nitrogen, liquid carbon dioxide, and mixtures thereof.

According to one embodiment, the method includes the step of dehydrating the solidified horticultural hydrogel. According to one embodiment, wherein the step of dehydrating the solidified horticultural hydrogel is carried out in a dehydration chamber at about 25° C.

A method of increasing plant mass is provided. The method includes the step of providing a horticultural hydrogel as provided herein and introducing a plant seed to the hydrogel. The method may optionally include the step of taking a step to aid in germination such as introducing water to the hydrogel. According to one embodiment, the hydrogel results in an increase in plant mass of at least about 10%, 20%, 30%, 40%, 50% or more relative to a plant grown in a horticultural hydrogel without bentonite.

### Statements of the Disclosure

These and other features of the disclosure will become more fully apparent from the following statements of the disclosure.

Statement 1: A horticultural hydrogel is provided, comprising water, carrageenan, and bentonite.

Statement 2: The horticultural hydrogel of Statement 1 further including carbon.

Statement 3: The horticultural hydrogel of Statement 2 further including activated carbon.

Statement 4: The horticultural hydrogel of any one of Statements 1-3 further including microcrystalline cellulose.

Statement 5: The horticultural hydrogel of any one of Statements 1-4 further including at least one fertilizer, biostimulant, or biofertilizer.

Statement 6: The horticultural hydrogel of Statement 5 including a fertilizer containing nitrogen, calcium, boron, copper, iron, manganese, molybdenum, zinc, or any combination thereof.

Statement 7: The horticultural hydrogel of any one of Statements 1-6 including calcium bentonite.

Statement 8: The horticultural hydrogel of any one of Statements 1-7 wherein the hydrogel is opaque.

Statement 9: The horticultural hydrogel of any one of Statements 1-8 wherein the hydrogel has a hardness ranging from about 40 g to about 2500 g.

Statement 10: The horticultural hydrogel of any one of Statements 1-9 wherein the hydrogel has a cohesiveness ranging from about 55.0% to about 90.0%.

Statement 11: The horticultural hydrogel of any one of Statements 1-10 wherein the hydrogel has a springiness ranging from about 90.0% to about 99.9%.

Statement 12: The horticultural hydrogel of any one of Statements 1-11, when seeded, results in an increase in plant mass relative to a plant grown in coir or peat.

Statement 13: The horticultural hydrogel of any one of Statements 1-12, when seeded, results in an increase in plant mass relative to a plant grown in a horticultural hydrogel that lacks bentonite.

Statement 14: The horticultural hydrogel of Statement 13 producing an increase in plant mass of at least about 5%, 10%, 15%, 20%, 30%, 40%, 50% or more.

Statement 15: The horticultural hydrogel of any one of Statements 1-14 supporting a spinach seed germination rate at least twice as fast as that in soil, peat, or coir.

Statement 16: The horticultural hydrogel of any one of Statements 1-15 including about 90.0% w/w to about 99.0% w/w water, about 0.50% w/w to about 5.0% w/w carrageenan, and about 0.50% w/w to about 5.0% w/w bentonite.

Statement 17: The horticultural hydrogel of any one of Statements 1-16, wherein the hydrogel is freeze-dried and reconstituted to contain about 90.0% w/w to about 99.9% w/w water.

Statement 18: The horticultural hydrogel of any one of Statements 1-16, wherein the hydrogel is frozen below 32° F. and subsequently thawed to at least 65° F. at least once.

Statement 19: The horticultural hydrogel of any one of Statements 1-16, wherein the hydrogel may lose water content such that the water content reaches about 60.0% w/w and may be rehydrated to about 90.0% w/w to about 99.9% w/w water.

Statement 20: The horticultural hydrogel of any one of Statements 1-19 supporting the growth of kale, spinach, butter lettuce, bok choy, or crunchy lettuce.

Statement 21: The horticultural hydrogel of any one of Statements 1-19 supporting the growth of berries, peppers, or herbs.

Statement 22: The horticultural hydrogel of Statement 21 supporting the growth of a berry, pepper, or herb selected from raspberry, strawberry, blackberry, blueberry, bell peppers, sweet peppers, basil, thyme, and sage.

Statement 23: The horticultural hydrogel of any one of Statements 1-22, wherein the hydrogel is formulated as a mat.

Statement 24: A horticultural hydrogel is provided, including about 90.0% w/w to about 99.0% w/w water, about 0.50% w/w to about 5.0% w/w carrageenan, about 0.50% w/w to about 5.0% w/w bentonite, and optionally about 0.01% w/w to about 3.0% w/w carbon, about 0.01% w/w to about 3.0% w/w microcrystalline cellulose, or about 0.01% w/w to about 3.0% w/w of at least one fertilizer, biostimulant, or biofertilizer.

Statement 25: The horticultural hydrogel of Statement 24, wherein the hydrogel is freeze-dried and reconstituted to have about 90.0% w/w to about 99.9% w/w water.

Statement 26: The horticultural hydrogel of Statement 24, wherein the hydrogel is frozen below 32° F. and thawed to at least 65° F. at least once.

Statement 27: The horticultural hydrogel of Statement 24, wherein the hydrogel may lose water content to about 60.0% w/w and may be rehydrated to about 90.0% w/w to about 99.9% w/w water.

Statement 28: The horticultural hydrogel of Statement 24, wherein the hydrogel is formulated as a mat.

Statement 29: The horticultural hydrogel of any one of Statements 24-28, wherein the hydrogel has a hardness ranging from about 40 g to about 2500 g.

Statement 30: The horticultural hydrogel of any one of Statements 24-29, wherein the hydrogel has a cohesiveness ranging from about 55.0% to about 90.0%.

Statement 31: The horticultural hydrogel of any one of Statements 24-30, wherein the hydrogel has a springiness ranging from about 90.0% to about 99.9%.

Statement 32: The horticultural hydrogel of any one of Statements 24-30, wherein the hydrogel has a springiness up to about 99.9%.

Statement 33: The horticultural hydrogel of any one of Statements 24-31, when seeded, results in an increase in plant mass relative to a plant grown in a horticultural hydrogel that lacks bentonite.

Statement 34: The horticultural hydrogel of Statement 33, wherein the hydrogel produces an increase in plant mass of at least about 5%, 10%, 15%, 20%, or more.

Statement 35: The horticultural hydrogel of any one of Statements 24-34, wherein the hydrogel supports the growth of kale, spinach, butter lettuce, bok choy, or crunchy lettuce.

Statement 36: The horticultural hydrogel of any one of Statements 24-34, wherein the hydrogel supports the growth of a berry, pepper, or herb.

Statement 37: The horticultural hydrogel of Statement 36, wherein the hydrogel supports the growth of a berry, pepper, or herb selected from raspberry, strawberry, blackberry, blueberry, bell peppers, sweet peppers, basil, thyme, and sage.

Statement 38: A method for increasing plant mass including providing a horticultural hydrogel of any one of Statements 1-36, introducing a plant seed into the hydrogel, and optionally introducing water to the hydrogel.

Statement 39: The method of Statement 38, wherein the hydrogel results in an increase in plant mass of at least about 5%, 10%, 15%, 20%, or more.

Statement 40: The method of Statement 38 or 39 supporting the cultivation of kale, spinach, butter lettuce, bok choy, or crunchy lettuce.

Statement 41: The method of Statement 38 or 39 supporting the cultivation of berries, peppers, or herbs.

Statement 42: The method of Statement 41 supporting the cultivation of a berry, pepper, or herb selected from raspberry, strawberry, blackberry, blueberry, bell peppers, sweet peppers, basil, thyme, and sage.

Statement 43: A method of preparing a horticultural hydrogel including heating water to about 80° C. to about 90° C., introducing one or more components selected from carrageenan, calcium bentonite clay, acidic activated carbon, calcium nitrate, and micronutrient fertilizer to the heated water to form a mixture, introducing the mixture to a plant plug mold, cooling the mixture within the mold to form a solidified hydrogel, optionally freezing the solidified hydrogel via blast freezing or cryogenic gas, and optionally dehydrating the solidified hydrogel, wherein the hydrogel may be used in its hydrated form directly for planting without freezing or drying.

Statement 44: The method of Statement 43, wherein the hydrogel uses reverse-osmosis purified water.

Statement 45: The method of Statement 43, heating the water to about 85° C.

Statement 46: The method of Statement 43, further including mixing the components with the heated water.

Statement 47: The method of Statement 46, including mixing the one or more components with a low-shear impeller at about 400 RPM.

Statement 48: The method of Statement 46, including mixing the one or more components for about 30 minutes.

Statement 49: The method of Statement 43, further including cooling the mixture to 70° C. and maintaining it at about 65° C. until introduction into the plant plug mold.

Statement 50: The method of Statement 43, further including cooling the mixture within the plant plug mold to about 4° C.

Statement 51: The method of Statement 43, including blast freezing the solidified hydrogel at about −40° C. or colder for at least 8 hours.

Statement 52: The method of Statement 43, including dehydrating the solidified hydrogel in a dehydration chamber at about 25° C.

Statement 53: A horticultural hydrogel is provided, including about 90.0% w/w to about 99.0% w/w water, about 0.50% w/w to about 5.0% w/w carrageenan, and about 0.50% w/w to about 5.0% w/w bentonite, wherein, when used as a growth medium for a plant, the hydrogel results in an increase in plant mass of at least about 10% relative to a plant grown in a horticultural hydrogel without bentonite.

Statement 54: The horticultural hydrogel of Statement 53, further including one or more of: about 0.01% w/w to about 3.0% w/w carbon, about 0.01% w/w to about 3.0% w/w microcrystalline cellulose, and about 0.01% w/w to about 3.0% w/w of at least one fertilizer, biostimulant, or biofertilizer.

Statement 55: The horticultural hydrogel of Statement 53, wherein the hydrogel is freeze-dried and reconstituted to have a water content of about 90.0% w/w to about 99.9% w/w water.

Statement 56: The horticultural hydrogel of Statement 53, wherein the hydrogel is formulated as a mat.

Statement 57: The horticultural hydrogel of Statement 53, wherein the hydrogel exhibits a hardness of from about 40 g to about 2500 g.

Statement 58: The horticultural hydrogel of Statement 53, wherein the hydrogel exhibits a cohesiveness of from about 55.0% to about 90.0%.

Statement 59: The horticultural hydrogel of Statement 53, wherein the hydrogel exhibits a springiness of from about 90.0% to about 99.9%.

Statement 60: The horticultural hydrogel of Statement 53, wherein the hydrogel supports the growth of kale, spinach, butter lettuce, bok choy, or crunchy lettuce.

Statement 61: The horticultural hydrogel of Statement 53, wherein the hydrogel supports the growth of a berry, pepper, or herb selected from the group consisting of raspberry, strawberry, blackberry, blueberry, bell peppers, sweet peppers, basil, thyme, and sage.

Statement 62: A method of increasing plant mass is provided, including providing a horticultural hydrogel of Statement 53, introducing a plant seed to the hydrogel, and optionally introducing water to the hydrogel, wherein, when used as a growth medium for a plant, the hydrogel results in an increase in plant mass of at least about 10% relative to a plant grown in a horticultural hydrogel without bentonite.

Statement 63: The method of Statement 62, supporting the cultivation of kale, spinach, butter lettuce, bok choy, or crunchy lettuce.

Statement 64: The method of Statement 63, supporting the cultivation of a berry, pepper, or herb selected from the group consisting of raspberry, strawberry, blackberry, blueberry, bell peppers, sweet peppers, basil, thyme, and sage.

Statement 65: A method of preparing a horticultural hydrogel is provided, including heating water to a temperature of from about 80° C. to about 90° C., introducing one or more components selected from the group consisting of carrageenan, bentonite, acidic activated carbon, calcium nitrate, and micronutrient fertilizer to the heated water to form a mixture, introducing the mixture to a plant plug mold, and cooling the mixture within the plug mold to form a solidified horticultural hydrogel.

Statement 66: The method of Statement 65, including cooling the mixture within the plant plug mold to about 4° C. to form a solidified horticultural hydrogel.

Statement 67: The method of Statement 65, further including the steps of freezing the solidified horticultural hydrogel via blast freezing or via a cryogenic gas selected from the group consisting of liquid nitrogen, liquid carbon dioxide, and mixtures thereof, and dehydrating the solidified horticultural hydrogel.

Statement 68: The method of Statement 67, including carrying out blast freezing at about −40° C. or less for at least 8 hours.

Statement 69: The method of Statement 67, including dehydrating the solidified horticultural hydrogel in a dehydration chamber at about 25° C.

These and other features of the disclosure will become more fully apparent from the following examples of the disclosure.

### Example 1

### Preparation of Freeze Thaw Horticultural Hydrogel Plug

A total of 95.09 kg of reverse-osmosis purified water was added to a 100 L glass reactor equipped with a low-shear impeller. The jacket temperature was set to 85° C., and stirring was adjusted to 100 RPM. Once the internal reactor temperature reached about 85° C. 2° C., the stirring speed was increased to about 400 RPM, and the solid ingredients were added: k-carrageenan (2.33 kg), calcium bentonite clay (1.00 kg), acidic activated carbon (1.00 kg), calcium nitrate (0.50 kg), and micronutrient fertilizer (0.080 kg). These conditions were maintained for about 30±5 minutes. After this period, the jacket temperature was reduced to below about 70° C., and stirring speed was decreased to about 250±50 RPM. The formulation was then transferred to a dispensing apparatus using a low-shear pump, ensuring that the mixture temperature remained about 65° C.±5° C. The dispenser directed the formulation into plant plug molds, which were equipped with dibblers for future seed placement. The filled molds were placed in a cold room maintained at about 4° C.±3° C. until the formulation solidified. A blast freezer, pre-cooled to about −40° C. 5° C., was used to freeze the molds for more than 8 hours. Afterward, the molds were removed and transferred to a dehydration chamber, where they were inverted. The dehydration chamber was set to about 25° C.±10° C., with air circulation. According to one embodiment, the air is filtered via a HEPA-filtered system to prevent the introduction of foreign components such as spores. After more than two days, the plugs were removed from the chamber and packaged for shipment.

### Example 2

### Alternative Simultaneous Addition Method of Preparing Freeze Thaw Horticultural Hydrogel Plug

The jacket temperature of the 100 L glass reactor, equipped with a low-shear impeller, was set to 85° C. Once the jacket temperature stabilized at about 85±2° C., the stirring speed was adjusted to about 400 RPM. Simultaneously, 95.09 kg of reverse-osmosis water, preheated to about 85° C. 2° C., was added along with the solid ingredients: 2.33 kg of k-carrageenan, 1.00 kg of calcium bentonite clay, 1.00 kg of acidic activated carbon, 0.50 kg of calcium nitrate, and 0.080 kg of micronutrient fertilizer. These conditions were maintained for 30±5 minutes. After this period, the jacket temperature was reduced to below about 70° C., and stirring speed was decreased to about 250±50 RPM. The formulation was then transferred to a dispensing apparatus using a low-shear pump, ensuring that the mixture temperature remained at about 65° C.±5° C. The dispenser directed the formulation into plant plug molds, which were equipped with dibblers for future seed placement. The filled molds were placed in a cold room maintained at about 4° C.±3° C. until the formulation solidified. A blast freezer, pre-cooled to—about 40° C.±5° C., was used to freeze the molds for more than eight hours. Afterward, the molds were removed and transferred to a dehydration chamber, where they were inverted. The dehydration chamber was set to about 25±10° C., with air circulation provided by a HEPA-filtered system. After more than two days, the plugs were removed from the chamber and packaged for shipment.

### Example 3

### Freeze Thaw Horticultural Hydrogel Plug with Calcium Bentonite

Experiments were conducted to evaluate the structural integrity of freeze thaw horticultural hydrogel plugs containing bentonite. The study used eight trays (six trays with 200 cells referred to as Batch 1 and two trays with 50 cells referred to as Batch 2). The two different batches (Batch 1 and Batch 2) were prepared, including the components and amounts set forth in Table 1.

TABLE 1

| Component | Amount (Batch 1) | | Amount (Batch 2) | |
|---|---|---|---|---|
| Reverse Osmosis Water | 2863 | g | 4771 | g |
| Kappa Carrageenan | 60 | g | 100 | g |
| Ricogel8800 | | | | |
| Calcium Bentonite Clay | 30 | g | 50 | g |
| Activated Carbon | 30 | g | 50 | g |
| Calcium Nitrate Yara | 15 | g | 25 | g |
| Florapro ® Calcium + Micros | 2.4 | g | 4 | g |

To prepare each horticultural hydrogel plug batch, water was first charged into a 5 L reactor and stirred at 600 rpm. The other formulation ingredients noted in Table 1 were added and stirring was reduced to 250 rpm. The resulting composition was then heated to about 85° C. and held for about 30 minutes before being cooled to about 75° C. and dispensed into trays equipped with dibblers and silicone mats and allowed to cool. After the plugs hardened, the dibblers were removed, and the trays were frozen with the silicone mats overnight in a blast freezer and then removed the following morning to form Batch 1 and Batch 2 of the freeze thaw horticultural hydrogel plugs.

The freeze-thaw horticultural hydrogel plugs that included bentonite demonstrated greater structural integrity compared to freeze thaw horticultural hydrogel plugs that did not include bentonite. Additionally, the structural integrity was increased while maintaining similar or better germination and growth outcomes. Thus, the use of calcium bentonite as a replacement for microcrystalline cellulose was demonstrated. The use of calcium bentonite is also believed to result in cost-effectiveness without compromising performance.

### Example 4

### Freeze Thaw Horticultural Hydrogel Plug with Lettuce

Experiments were conducted to identify which freeze thaw horticultural hydrogel plug provides the best performance for lettuce growth and overall plant health. The experiment tested three different formulations set forth in Table 2 using trays containing 200 cells each.

TABLE 2

| | | | | | | Florapro ® | |
|---|---|---|---|---|---|---|---|
| | RO | | Calcium | Activated | Calcium | Calcium + | |
| | Water | Carrageenan | Bentonite | Carbon | Nitrate | Micros | Microcrystalline |
| Trial | (g) | (%) | (%) | (g) | (g) | (g) | Cellulose (g) |
| 1 | 2863 | 60 | 30 | 30 | Calcium | 2.4 | 78.46, 64.04, |
| | | | | | Nitrate | | 101.55 |
| | | | | | Yara: 15 g | | |
| 2 | 2889.6 | 75 | N/A | 30 | Potassium | 2.4 | 83.97, 62.44, |
| | | | | | Nitrate: 3 g | | 78.52 |
| 3 | 2873 | 82.5 | N/A | 30 | Calcium | 2.4 | 11.78, 78.99, |
| | | | | | Nitrate | | 102.43 |
| | | | | | Yara: 12 g | | |

To prepare each horticultural hydrogel plug trial, water was first charged water into a 5 L reactor and stirred at 600 rpm. The formulation other ingredients noted in Table 2 were added and stirring was reduced to 250 rpm. The resulting composition was then heated to about 85° C. and held for 30 minutes before being cooled to about 75° C. and dispensed into trays equipped with dibblers and silicone mats and allowed to cool. After the plugs hardened, the dibblers were removed, and the trays were frozen with the silicone mats overnight in a blast freezer and then removed the following morning to form the freeze thaw horticultural hydrogel plugs.

Lettuce was allowed to germinate and grow in the freeze thaw horticultural hydrogel plugs. Plant mass at 14 days was recorded as reflected in Table 2.

Based upon these results, the freeze thaw horticultural hydrogel plugs that included bentonite appear to provide similar growth performance as freeze thaw horticultural hydrogel plugs without bentonite. The freeze thaw horticultural hydrogel plugs including potassium nitrate appeared to be slightly inferior compared to those including bentonite, but not in a statistically significant manner. The germination rate was also shown to be slightly higher for freeze thaw horticultural hydrogel plugs including bentonite. The freeze thaw horticultural hydrogel plugs including bentonite were shown to have more structural integrity compared to the other tested freeze thaw horticultural hydrogel plugs. Thus, this experiment illustrated that lower overall cost horticultural hydrogel plugs containing bentonite are able to maintain structural integrity.

### Example 5

### Horticultural Hydrogel Plug—Microgreens

Experiments were conducted to optimize the formulation of a horticultural hydrogel microgreens mat that includes calcium bentonite. The experiments evaluated various formulations to determine the most effective combination for enhancing microgreens plant growth. Different hydrogel formulations were prepared as illustrated in Table 3 by varying the concentrations of key ingredients such as carrageenan, calcium bentonite, activated carbon, calcium nitrate, and Florapro® Calcium+Micros fertilizer. The experiments were conducted using a 2-liter reactor with controlled stirring and temperature conditions.

TABLE 3

| | | | | | | Florapro ® | |
|---|---|---|---|---|---|---|---|
| | RO | | Calcium | Activated | Calcium | Calcium + | |
| | Water | Carrageenan | Bentonite | Carbon | Nitrate | Micros | Microcrystalline |
| Trial | (g) | (%) | (%) | (g) | (g) | (g) | Cellulose (g) |
| 1 | 978.5 | 10 | 5 | 3 | 2.5 | 0.667 | 0.333 |
| 2 | 963.5 | 15 | 15 | 3 | 2.5 | 0.667 | 0.333 |
| 3 | 963.5 | 15 | 15 | 3 | 2.5 | 0.667 | 0.333 |
| 4 | 973.5 | 15 | 5 | 3 | 2.5 | 0.667 | 0.333 |
| 5 | 973.5 | 15 | 5 | 3 | 2.5 | 0.667 | 0.333 |
| 6 | 968.5 | 10 | 15 | 3 | 2.5 | 0.667 | 0.333 |
| 7 | 963.5 | 15 | 15 | 3 | 2.5 | 0.667 | 0.333 |
| 8 | 973.5 | 15 | 5 | 3 | 2.5 | 0.667 | 0.333 |
| 9 | 971.0 | 12.5 | 10 | 3 | 2.5 | 0.667 | 0.333 |
| 10 | 968.5 | 10 | 15 | 3 | 2.5 | 0.667 | 0.333 |
| 11 | 978.5 | 10 | 5 | 3 | 2.5 | 0.667 | 0.333 |
| 12 | 971.0 | 12.5 | 10 | 3 | 2.5 | 0.667 | 0.333 |

Each trial mat was prepared by first introducing the components of Table 3 into a 2 L reactor and initiating stirring at 500 RPM. Formulation-related ingredients were then added and stirring was decreased to 300 RPM. The resulting composition was heated to about 85° C. and then cooled to room temperature at 200 RPM. Each trial mat composition was then poured into HarvestRight™ trays to hold the mat compositions during the cooling and solidification process.

The results indicated that calcium bentonite significantly enhanced growth, while carrageenan did not have a substantial impact. The optimal formulation included 1.5% carrageenan and 1.5% calcium bentonite, providing a balance between structure and growth performance.

### Example 6

### Freeze Dried and Freeze Thaw Horticultural Hydrogel Plugs

Experiments were conducted on two horticultural hydrogel formulations, freeze dried with bentonite and freeze thawed with bentonite, to evaluate their physical properties (cohesiveness, hardness, and springiness). These formulations are tested both after freeze-drying and after rehydration to determine changes in texture and performance characteristics.

To prepare both the freeze dried and freeze thaw horticultural hydrogel plugs, water was first charged into a 5 L reactor and stirred at 600 rpm. The formulation ingredients noted in Table 4 were added and stirring was reduced to 300 rpm after about 10 minutes. The resulting composition was then heated to about 85° C. and held for about 30 minutes before being cooled to about 75° C. and poured into a 200-cell tray. Once cooled, the horticultural hydrogel plugs were frozen in a pre-cooled blast freezer. One tray of horticultural hydrogel plugs was then subject to a freeze dry process.

TABLE 4

| Component | Amount | |
|---|---|---|
| RO Water | 2,870 | g |
| Ricogel8800 (240224A) | 75 | g |
| Bentonite | 30 | g |
| Activated Carbon | 18 | g |
| Yara Ca(NO₃)₂ | 6 | g |
| Florapro ® Calcium + Micros | 2 | g |
| Microcrystalline Cellulose | 0.6 | g |
| (ThermoSci) | | |

The physical properties of cohesiveness, hardness, and springiness were evaluated. The results are provided in Table 5.

TABLE 5

| | | Cohesiveness | Hardness | Springiness |
|---|---|---|---|---|
| Formulation | Condition | (%) | (g) | (%) |
| Freeze Dried | After Freeze- | 34.38 | 1771.62 | 94.21 |
| | Drying | | | |
| Freeze Dried | After | 71.14 | 114.48 | 94.19 |
| | Rehydrating | | | |
| Freeze Thaw | After Freeze- | 63.40 | 81.95 | 96.07 |
| | Thawing | | | |
| Freeze Thaw | After | 68.63 | 77.76 | 92.42 |
| | Rehydrating | | | |

Texture analysis was conducted to determine the hardness, cohesiveness, and springiness of horticultural hydrogel plugs. Five undibbled plugs were first checked for uniformity and the absence of defects and then soaked in about 300 mL of reverse osmosis (RO) water for approximately three to four hours at room temperature. Following hydration, plugs were drained and prepared for testing.

A Texture Analyzer (Stable Micro Systems) was calibrated for both force and height prior to testing. Each plug was positioned on the analysis platform, and the compression arm was adjusted to meet the top surface of the plug. The analyzer program was set to perform two compression cycles, with each plug compressed to a deformation of about 5 mm, corresponding to approximately 10% of the plug height.

During testing, the analyzer recorded parameters including peak force, positive distance, and positive area (force-time). After all five plugs were tested, the data were processed using the instrument's software. Quick calculations were performed to extract values for absolute positive force, absolute positive distance, peak force, and positive area. The “TPA Macro” function was applied to ensure accurate peak force determination. Data were then exported into a spreadsheet for calculation of texture parameters.

Hardness was defined as the peak force of the first compression cycle. Cohesiveness was defined as the ratio of the average positive area of the second compression cycle to the average positive area of the first compression cycle. Springiness was defined as the ratio of the average force of the first compression cycle to the average force of the second compression cycle. All calculations were verified for alignment and accuracy within the spreadsheet.

The results indicated significant changes in texture properties following freeze-drying and freeze-thawing processes, with freeze dried horticultural hydrogel plugs with bentonite showing higher cohesiveness and hardness after rehydration compared to freeze thaw horticultural hydrogel plugs with bentonite.

### Example 7

### Microcrystalline Cellulose in Freeze Thaw Horticultural Hydrogel Plugs

Experiments were conducted to evaluate the use of bentonite and microcrystalline cellulose in freeze thaw horticultural hydrogel plugs. The experiments also aimed to determine which plug component (bentonite or microcrystalline cellulose) contributes to a stronger plug while also supporting plant growth.

To prepare freeze thaw horticultural hydrogel plugs, water was first charged into a 5 L reactor and stirred at 600 rpm. The formulation ingredients noted in Table 6 were added and stirring was reduced to 300 rpm after about 10 minutes. The resulting composition was then heated to about 85° C. and held for about 30 minutes before being cooled to about 75° C. and poured into a 200-cell tray equipped with a dibbler and silicone mat. Once cooled, the dibbler was removed, and the horticultural hydrogel plugs were frozen in a pre-cooled blast freezer and then thawed at room temperature overnight to produce the freeze thaw horticultural hydrogel plugs.

TABLE 6

| | | | | | Trial 3 | | | |
|---|---|---|---|---|---|---|---|---|
| | | | Trial 2 | | (both | | | |
| | Trial 1 | | (no bentonite | | bentonite | | Trial 4 | |
| | (no bentonite | | but with | | and | | (bentonite | |
| Component | or cellulose) | | cellulose) | | cellulose) | | only) | |
| RO Water | 2,893 | g | 2890 | g | 2860 | g | 2863 | g |
| Ricogel8800 | 60 | g | 60 | g | 60 | g | 60 | g |
| (240224A) | | | | | | | | |
| Bentonite | 0 | g | 0 | g | 30 | g | 30 | g |
| Activated | 30 | g | 30 | g | 30 | g | 30 | g |
| Carbon | | | | | | | | |
| Yara Ca(NO₃)₂ | 15 | g | 15 | g | 15 | g | 15 | g |
| Florapro ® | 2.4 | g | 2.4 | g | 2.4 | g | 2.4 | g |
| Calcium + | | | | | | | | |
| Micros | | | | | | | | |
| Microcrystalline | 0 | g | 3 | g | 3 | g | 0 | g |
| Cellulose | | | | | | | | |
| (ThermoSci) | | | | | | | | |

Hardness measurements were taken using a Stable Micro Systems TA.XT Express Texture Analyzer (TA). The TA was powered on and calibrated with a 2000 g weight for weight and for height. The following measurements were measured: distance (mm), force (g), time (sec) and temperature (° F.). Pre-test speed was set to a compression value of 1.00 mm/sec, Test Speed was set to a compression value of 1.00 mm/sec, Post-test speed was set to a compression value of 2.00 mm/sec. Target mode Strain was set to 25.0% and a Count value of 2. Trigger Type of Force was set to a Trigger Force value of 5.0 g. Each hydrogel plug was placed directly underneath the TA probe and “Start Test” was selected. “Up” and “Fast” buttons were selected where the height needed to be adjusted to a higher setting to accommodate the plug. Results for absolute positive force, absolute positive distance, peak force, and positive area were collected. Cohesiveness measurements (the hydrogel's ability to return to original height after compression) and springiness (tested twice with compressive force, Force2/Force1×100%) were then measured. Plant growth was also noted. All experimental results are provided in Table 7.

TABLE 7

| | | | | | | | | Total |
|---|---|---|---|---|---|---|---|---|
| | | | | Butter | | | Crystal | Wet |
| | Cohesiveness | Hardness | Springiness | Lettuce | Arugula | Kale | Lettuce | Weight |
| Trial | (%) | (g) | (%) | (g) | (g) | (g) | (g) | (g) |
| 1 | 46.44 | 35.15 | 93.65 | 16.36 | 4.54 | 24.38 | 10.08 | 55.35 |
| 2 | Too soft to | Too soft to | Too soft to | 32.57 | 7.37 | 56.03 | 14.76 | 110.71 |
| | acquire data | acquire data | acquire data | | | | | |
| 3 | 51.84 | 56.81 | 92.81 | 17.49 | 14.22 | 45.32 | 15.78 | 92.81 |
| 4 | 63.40 | 81.95 | | | | | | |

Trial formulation 4 (bentonite) was identified as the strongest horticultural hydrogel plug based on texture analysis, exhibiting the highest cohesiveness, hardness, and springiness. The addition of microcrystalline cellulose was shown to weaken the plug structure (making too soft for reliable data collection) but a significant increase in plant growth was observed, particularly in terms of total wet weight. Trial formulation 3 strengthened the horticultural hydrogel plug while also enhancing plant mass.

### Example 8

### Preparation of Horticultural Hydrogel

A horticulture hydrogel was prepared according to the methods provided herein with the components set forth in Table 8.

TABLE 8

| Component | Amount (g) |
|---|---|
| Reverse Osmosis (RO) Water | 2858 |
| Kappa Carrageenan (Ricogel 8800) | 45 |
| Bentonite Clay | 45 |
| Activated Carbon | 9 |
| Calcium Nitrate | 7.5 |
| Microcrystalline Cellulose | 1 |
| Florapro ® Calcium + Micros | 2 |

First, reverse osmosis water (2858 g) was added to a 5-liter jacketed glass reactor equipped with an overhead mechanical stirrer. Stirring was initiated at 970 revolutions per minute (rpm) to ensure rapid dispersion.

With stirring maintained at 970 rpm, the dry components (kappa carrageenan, bentonite clay, activated carbon, calcium nitrate, microcrystalline cellulose, and Florapro® Calcium+Micros) were added sequentially to the reactor. Each ingredient was allowed to disperse before the addition of the next.

After the final addition, the stirring rate was reduced to 400 rpm. The mixture was then heated to about 85° C. and held at that temperature for about thirty minutes to allow complete hydration and interaction of the gelling and particulate components.

After the hold period, the temperature was lowered and maintained at about 75±5° C. The formulation was then transferred into 200×1.75″ trays (available from T.O. Plastics, Inc.) and allowed to cool with a dibbler placed on top of the plugs, forming a wet gel plant plug upon cooling. These plugs were seeded with fairly lettuce, arugula, spinach, kale and hydrolique lettuce and placed in a nursery under LED grow lights and sitting in a tray of reverse-osmosis water with humidity domes. The germination rates were 95%, 100%, 100%, 100%, and 100%, respectively. The plants were grown for two weeks, at which time the plants were cut just above the root level and weighed. Growth plant masses were measured are provided in Table 9.

TABLE 9

| | | | | | | Total Wet |
|---|---|---|---|---|---|---|
| Trial | Fairly | Arugula | Spinach | Kale | Hydrolique | Weight (g) |
| 1 | 32.4 g | 10.6 g | 40.5 g | 31.5 g | 30.6 g | 145.6 g |

These results demonstrated a structurally sound hydrogel plug containing bentonite and microcrystalline cellulose, which achieved spinach germination and growth while also maintaining strong results with other cultivars as set forth in Table 9.

### Example 9

### Horticultural Hydrogel Stability

Horticulture hydrogels were prepared according to the methods provided herein with the components set forth in Table 10.

TABLE 10

| Component | Amount (g) |
|---|---|
| Reverse Osmosis (RO) Water | 2853 |
| Kappa Carrageenan | 70 |
| (Ricogel8800) | |
| Calcium Bentonite Clay | 30 |
| Activated Carbon | 30 |
| Calcium Nitrate (Yara) | 15 |
| Florapro ® Calcium + Micros | 2.4 |

Reverse osmosis water (2853 g) was charged into a 5-liter jacketed reactor and stirred at 600 rpm. Dry formulation ingredients set forth in Table 10 were added sequentially to form a mixture. After the final addition, the stirring rate was reduced to 400 rpm. The mixture was then heated to about 85° C. and held at that temperature for thirty minutes to allow complete hydration and interaction of the gelling and particulate components. The mixture was then cooled to about 75±5° C. and poured into T50 trays (available Landmark Plastic) equipped with dibblers. Once tray filling was complete, the mixture was blast frozen overnight and subsequently dried in a dehydration chamber to form freeze-dried horticultural hydrogel plugs.

Two sets of fifty horticultural hydrogel pugs were prepared according to the aforementioned procedure but with different drying steps. One set of horticultural hydrogel plugs was stored at ambient temperature under air (no carbon dioxide). A second set of fifty horticultural hydrogel plugs were prepared that were sealed in a 30% carbon dioxide/70% nitrogen environment and stored at room temperature.

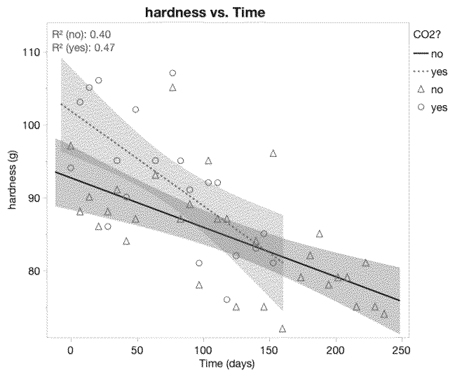

Each week after preparation, five horticultural hydrogel plugs from each of the aforementioned sets were soaked in 300 g of reverse osmosis water for about four hours and analyzed for hardness using a TA texture analyzer (1 cycle per plug). The average hardness (in grams) was recorded. The graph in FIG. 1 illustrates the change in plug hardness over time, comparing storage between the two sets of horticultural hydrogel plugs.

These results demonstrate that horticultural hydrogel plugs sealed in a 30% carbon dioxide/70% nitrogen environment lost more mechanical integrity over time than those stored under no additional carbon dioxide (i.e., air). The hydrogel plugs sealed in a 30% carbon dioxide/70% nitrogen environment study was discontinued at 153 days because carbon dioxide was clearly shown to not help with stability. After 250 days the air-dried horticultural hydrogel plugs were still usable to grow plants.

### Example 10

### Bentonite Horticultural Hydrogels

Experiments were conducted to compare the plant growth performance of a control horticultural hydrogel (no bentonite) against an experimental horticultural hydrogel containing bentonite, using kale (Brassica oleracea) and spinach (Spinacia oleracea) as model plant species. The control horticultural hydrogel included carrageenan and other optional additives as set forth in Table 11. The experimental horticultural hydrogel included the components set forth in Table 12.

TABLE 11

| Component | Control | |
|---|---|---|
| RO Water | 2,873 | g |
| Kappa Carrageenan (Ricogel8800) | 82.5 | g |
| Activated Carbon | 30 | g |
| Calcium Nitrate (Yara) | 12 | g |
| Florapro ® Calcium + Micros | 2.4 | g |

TABLE 12

| Component | Experimental | |
|---|---|---|
| RO Water | 2,863 | g |
| Kappa Carrageenan | 60 | g |
| (Ricogel8800) | | |
| Activated Carbon | 30 | g |
| Calcium Nitrate (Yara) | 15 | g |
| Florapro ® Calcium + Micros | 2.4 | g |
| Calcium Bentonite Clay | 30 | g |

Control and experimental horticultural hydrogel plugs were manufactured and dehydrated according to the following procedure. Reverse osmosis water of the amounts set forth in Table 11 and Table 12 was charged into a 5-liter jacketed reactor and stirred at about 600 rpm. Dry formulation ingredients set forth in Table 11 and Table 12 were added sequentially to form a mixture. After the final addition, the stirring rate was reduced to about 400 rpm. The mixture was then heated to about 85° C. and held at that temperature for thirty minutes to allow complete hydration and interaction of the gelling and particulate components. The mixture was then cooled to about 75±5° C. and poured into T50 trays (available from Landmark Plastic) equipped with dibblers. Once tray filling was complete, the mixture was blast frozen overnight and subsequently dried in a dehydration chamber to form freeze-dried horticultural hydrogel plugs.

Kale and spinach seeds were surface-sterilized and planted into individual plugs, with forty (n=40) plugs prepared per treatment group. Prior to planting, the plugs were hydrated to saturation using reverse osmosis (RO) water. The planted plugs were maintained in a nursery environment under a 16-hour light and 8-hour dark photoperiod. No supplemental nutrients were applied beyond those contained in the hydrogel composition. Plant growth was monitored over a 14-day period, after which the aboveground biomass was harvested and weighed for each plug to determine the fresh weight in grams. The results are provided in Table 13.

TABLE 13

| | | Average Plant | Standard |
|---|---|---|---|
| Treatment | Species | Mass (g) | Deviation (g) |
| FT (Control) | Kale | 0.26 | 0.09 |
| FT-B (Test) | Kale | 0.41 | 0.05 |
| FT (Control) | Spinach | 0.18 | 0.05 |
| FT-B (Test) | Spinach | 0.28 | 0.09 |

The experimental horticultural hydrogel plugs showed an increase in average fresh mass relative to the control horticultural hydrogel plugs of about 58% in kale and about 56% in spinach. These results demonstrate that the inclusion of bentonite in horticultural hydrogel plugs improves plant growth performance, as evidenced by increased fresh biomass in both kale and spinach.

We claim:

1. A horticultural hydrogel comprising:
about 90.0% w/w/to about 99.0% w/w water;
about 0.50% w/w to about 5.0% w/w carrageenan; and
about 0.50% w/w/to about 5.0% w/w bentonite,
wherein, when used as a growth medium for a plant, the horticultural hydrogel results in an increase in plant mass of at least about 10% relative to a plant grown in a horticultural hydrogel without bentonite.

2. The horticultural hydrogel of claim 1 further comprising one or more of:
about 0.01% w/w to about 3.0% w/w carbon;
about 0.01% w/w to about 3.0% w/w microcrystalline cellulose; and
about 0.01% w/w to about 3.0% w/w of at least one fertilizer, biostimulant, biofertilizer, or a combination thereof.

3. The horticultural hydrogel of claim 1, wherein the horticultural hydrogel is freeze dried and reconstituted to have a water content of about 90.0% w/w water to about 99.9% w/w water.

4. The horticultural hydrogel of claim 1, formulated as a mat.

5. The horticultural hydrogel of claim 1, wherein the horticultural hydrogel exhibits a hardness of from about 40 g to about 2500 g.

6. The horticultural hydrogel of claim 1, wherein the horticultural hydrogel exhibits a cohesiveness of from about 55.0% to about 90.0%.

7. The horticultural hydrogel of claim 1, wherein the horticultural hydrogel exhibits a springiness of from about 90.0% to about 99.9%.

8. The horticultural hydrogel of claim 1, wherein the plant is kale, spinach, butter lettuce, bok choy, or crunchy lettuce.

9. The horticultural hydrogel of claim 1, wherein the plant is a berry, pepper, or herb selected from the group consisting of raspberry, strawberry, blackberry, blueberry, bell peppers, sweet peppers, basil, thyme, and sage.

10. A method of increasing plant mass comprising:
providing a horticultural hydrogel of claim 1;
introducing a plant seed to the hydrogel; and
optionally, introducing water to the hydrogel,
wherein, when used as a growth medium for a plant, the horticultural hydrogel results in an increase in plant mass of at least about 10% relative to a plant grown in a horticultural hydrogel without bentonite.

11. The method of claim 10, wherein the plant is kale, spinach, butter lettuce, bok choy, or crunchy lettuce.

12. The method of claim 11, wherein the plant is a berry, pepper, or herb selected from the group consisting of raspberry, strawberry, blackberry, blueberry, bell peppers, sweet peppers, basil, thyme, and sage.

13. A method of preparing a horticultural hydrogel comprising the steps of:
heating water to a temperature of from about 80° C. to about 90° C.;
introducing one or more components to the heated water to form a mixture, the one or more components selected from the group consisting of carrageenan, bentonite, acidic activated carbon, calcium nitrate, and micronutrient fertilizer;
introducing the mixture to plant plug mold; and
cooling the mixture within the plug mold to form a solidified horticultural hydrogel.

14. The method of claim 13, wherein the step of cooling the mixture within the plug mold to form a solidified horticultural hydrogel is carried out at about 4° C.

15. The method of claim 13, further comprising the steps of:
freezing the solidified horticultural hydrogel via blast freezing or via applying a cryogenic gas selected from the group consisting of liquid nitrogen, liquid carbon dioxide, and mixtures thereof; and
dehydrating the solidified horticultural hydrogel.

16. The method of claim 15, wherein the step of blast freezing the solidified horticultural hydrogel is carried out at about −40° C. or less for at least 8 hours.

17. The method of claim 15, wherein the step of dehydrating the solidified horticultural hydrogel is carried out in a dehydration chamber at about 25° C.
